(19) United States
(12) Patent Application Publication
(10) Pub. No.: US 2017/0263095 A1
(43) Pub. Date: Sep. 14, 2017

(54) Appliances Built-in Safety Features

(71) Applicant: Percival A. Peck, Miramar, FL (US)

(72) Inventor: Percival A. Peck, Miramar, FL (US)

(21) Appl. No.: 15/067,452

(22) Filed: Mar. 11, 2016

(51) Int. Cl. G08B 17/10; G05B 9/02

(52) U.S. Cl. CPC G08B 17/10; G05B 9/02

(57) ABSTRACT

A safety device is provided that could be incorporated in an electrical appliance and the safety device is configured to sense any smoke produced by the faulty or overheated electrical appliance and immediately shutting off the electrical appliance. The safety device includes at least one smoke detector sensor installed near the control panel or operating parts of the electrical appliance, and a mechanism to shut off the electrical appliance that is hardwired to the smoke detector.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention generally relates to a safety device for electrical household and commercial appliances and in particular, the invention relates to a device for automatically shutting off the electrical appliance in case any smoke is detected from the electrical appliance.

2. Description of Related Art Including Information Disclosed Under 37 CFR 1.97 and 37 CFR 1.98

The electrical appliances have been one of the leading causes of household fires. The household appliances typically range from small electrical appliances such as mixers, blenders, cookers, fryers, electrical skillets, toasters, grillers etc. to large electrical appliances including oven, washing machine etc. Similarly, the commercial appliances range from small to large electrical appliances including electrical machineries. The electrical appliance in use may become faulty or the appliance when used for longer period may overheat, for example, a user may simply forget about the running electrical appliance, the unattended electrical appliance could overheat resulting in smoke and flames. The flames may cause fire and the continued running of the appliance may further exacerbate the fire.

The households and commercial establishments are generally equipped with smoke detectors that include sensors for detecting the presence of smoke, and alarms to alert the concerned persons in case smoke is detected. However, such smoke detectors could not shut off the faulty or overheated electrical appliance. Moreover, the smoke detectors are typically mounted on ceilings and may be located far away from the location of the electrical appliance. Thus, the smoke detectors may be out of range for detecting small amount of smoke produced from faulty or over heated electrical appliance, but the smoke detectors could sense the smoke only when the smoke levels are increased or the appliance is close to generating flames or explosion.

Thus, a need could be appreciated for a safety device for use in electrical appliances that could detect small levels of smoke produced by faulty or overheated electrical appliance and could immediately shutoff the appliance, thus reducing the chances of fire.

### BRIEF SUMMARY OF THE INVENTION

The present invention, therefore, has as its principal object to provide a safety device for electrical appliance that could sense smoke from a faulty or overheated electrical appliance.

Another object of present invention is that safety device could shut off the faulty or overheated electrical appliance.

Still, another object of the present invention is that the safety device could detect small levels of smoke produced by the faulty or overheated electrical appliance.

Still, another object of present invention is that the safety device decreases the chances of a fire caused by faulty or overheated electrical appliances.

An additional object of present invention is that the safety device may not require human intervention to cut the power supply.

A further object of present invention is that the safety device could prevent any major damage to electrical appliance due to overheating and/or fire.

A still further object of present invention is that the safety device could save the user from huge financial and property losses caused by fire.

Yet, another object of present invention is that the safety device is economic to manufacture and easy to install in electrical appliances.

Certain embodiments of present invention provide a safety device that could be incorporated in an electrical appliance and the safety device is configured to sense any smoke produced by the faulty or overheated electrical appliance and immediately shutting off the electrical appliance. The safety device comprises at least one smoke detector integrated in the electrical appliance, and a means to shut off the electrical appliance hardwired to the smoke detector. Furthermore, the safety device comprises an alarm module to alert a concerned person that the smoke is detected from the electrical appliance.

In addition to the various objects and advantages of the present invention described with some degree of specificity above it should be obvious that additional objects and advantages of the present invention will become more readily apparent to those persons who are skilled in the relevant art from the following more detailed description of the invention.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is the diagrammatic view of an electrical appliance with safety device showing the smoke detector hardwired to circuit breaker.

### DETAILED DESCRIPTION OF THE INVENTION

The present invention provides a safety device for use in electrical appliances to detect any smoke produced by faulty or overheated electrical appliance and automatically shut off the appliance.

Before explaining at least one embodiment of the invention in detail, it is to be understood that the invention is not limited in its application to the details of construction and the arrangements of the components set forth in the following description. The invention is capable of other embodiments and of being practiced and carried out in various ways. In addition, it is to be understood that the phraseology and terminology employed herein are for the purpose of description and should not be regarded as limiting.

As used in this specification and the appended claims, the singular forms “a”, “an”, and “the” include plural referents unless the content clearly dictates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

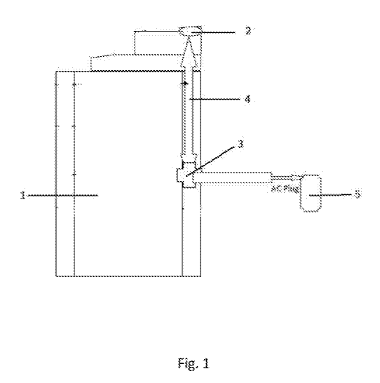

Referring to FIG. 1 showing the diagrammatic view of the electrical appliance range 1 incorporated with the safety device of present invention. The safety device includes a smoke detector sensor 2 installed in the electrical appliance. The electrical appliance could be any household electrical appliance including electrical kitchen appliances, such as toaster, oven, electrical stove, heater etc. to large household and commercial electrical appliances. The electrical appliance typically includes power supply and functioning parts. The functioning parts of electrical appliances include electric motor, heating coils, etc. The functioning parts are particularly susceptible to a fault that may result in smoke and flames. Besides fault in electrical appliance, longer use of electric appliance or unattended use of electrical appliance may result in overheating of the electrical appliance causing smoke and/or flames. The power supply of electrical appliances including conducting wires is also susceptible for fault or overheating. Particular adaptors used in power supply for converting AC current to DC and vice versa are susceptible to overheat. Furthermore, it is obvious that there could be myriad of reasons that an electrical appliance not functioning properly and produce smoke.

As shown in FIG. 1, the safety device includes a smoke detector 2 integrated in the electrical appliance. The smoke detector is preferably mounted near the functioning parts of the electrical appliance or the smoke detector could be mounted on top portion of electrical appliance, as the smoke produced from any portion of the electrical appliance would rise to top portion of the electrical appliance. The smoke detector could be any conventional smoke detector adapted for integrating into the electrical appliance. The construction and working of smoke detectors is obvious to a skilled person including sensing of smoke and producing a signal in response to the detected smoke.

The smoke detector is hard wired 4 to a circuit breaker 3 that is integrated in the power supply of the electrical appliance. The circuit breaker receives the signal produced by the smoke detector in response to the detected smoke, and on receiving the signal, the circuit breaker is tripped cutting off the power supply to the electrical appliance and thus shutting off the electrical appliance. The construction and working of circuit breakers is obvious to a skilled person for example DC circuit breaker is known that could be mounted in the electrical appliance and interrupt the power supply to the appliance. When the circuit is complete, the current could normally flow to the functioning parts of the electrical appliance and when the circuit is tripped, the current could not flow to the functional parts of the electrical appliance, thus shutting off the appliance.

The safety device further includes an alarm module operably coupled to the smoke detector and is provided to alert a concerned person that the electrical device is producing smoke. Although the safety device does not require human intervention in shutting off the electrical device, the provision of alarm could be advantageous for letting the concerned person know that the device is producing smoke. For example, a person using a mixer may know by hearing the alarm that the mixer was suddenly stopped by the safety device of present invention and the electrical device was not safe for operation. The alarm could be any audible alert such as beep.

The invention is advantageous by detecting even small levels of smoke produced by the electrical appliance, shutting off the electrical appliance preventing any chances of fire and further damage to the electrical appliance. Typically, a faulty or overheated electrical appliance produces smoke first that could be followed by flames or explosion. Thus, detecting the smoke and immediately shutting off the device prevent any fire hazard and major damage to the electrical appliance. The safety device further includes a reset mechanism, such as a push button operably coupled to the circuit breaker that is used to complete the tripped circuit. When the electrical appliance is brought to normal working state, for example, the overheated electrical appliance is cooled to room temperature, or the fault in electrical appliance is removed, the reset mechanism could be used to redo the tripped circuit, thus permitting the current to flow to the functional parts of electrical appliance.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

I claim:

1. An integrated safety device for an electrical appliance configured to detect smoke produced by fault or overheating of said electrical appliance and shutting off said electrical appliance, said safety device comprising:
a. a smoke detector mounted in said electrical appliance and configured to sense smoke and generate a signal,
b. a shutoff means hardwired to said smoke detector, said shutoff means is configured to receive a signal from said smoke detector and shutoff said electrical appliance.

2. The integrated safety device according to claim 1, wherein said shutoff means is a circuit breaker, said circuit breaker is integrated in a power supply of said electrical appliance, said circuit breaker is adapted to be tripped on receiving the signal from said smoke detector cutting the power supply to said electrical appliance.

3. The integrated safety device according to claim 1, wherein said safety device further comprises a reset mechanism, said reset mechanism is operably coupled to said shutoff means and configured to permit turning on said electrical appliance.

4. The integrated safety device according to claim 1, wherein said shutoff means is a circuit breaker, said circuit breaker is integrated in a power supply of said electrical appliance, said circuit breaker is adapted to be tripped on receiving the signal from said smoke detector cutting the power supply to said electrical appliance, said integrated safety device further comprising a reset mechanism operably coupled to said circuit breaker, said reset mechanism configured to complete said tripped circuit permitting the power supply to said electrical appliance.

5. The integrated safety device according to claim 1, wherein said integrated safety device further comprises an alarm module operably coupled to the smoke detector, said alarm module is configured to receive said signal from said smoke detector and generate an audible alarm.

6. The integrated safety device according to claim 1, wherein said electrical appliance is an electrical kitchen appliance.

7. The integrated safety device according to claim 1, wherein said electrical appliance is an electrical household appliance.

8. The integrated safety device according to claim 1, wherein said electrical appliance is an electrical commercial appliance.

9. An electrical appliance with an integrated safety device, said safety device configured to detect smoke produced by fault or overheating of said electrical appliance and shutting off said electrical appliance, said integrated safety device comprising:
a. a smoke detector mounted in said electrical appliance and configured to sense smoke and generate a signal,
b. a shutoff means hardwired to said smoke detector, said shutoff means is configured to receive a signal from said smoke detector and shutoff said electrical appliance.

10. The electrical appliance according to claim 9, wherein said shutoff means is a circuit breaker, said circuit breaker is integrated in a power supply of said electrical appliance, said circuit breaker is adapted to be tripped on receiving the signal from said smoke detector cutting the power supply to said electrical appliance.

11. The electrical appliance according to claim 9, wherein said integrated safety device further comprises a reset mechanism, said reset mechanism is operably coupled to said shutoff means and configured to permit turning on said electrical appliance.

12. The electrical appliance according to claim 9, wherein said shutoff means is a circuit breaker, said circuit breaker is integrated in a power supply of said electrical appliance, said circuit breaker is adapted to be tripped on receiving the signal from said smoke detector cutting the power supply to said electrical appliance, said integrated safety device further comprising a reset mechanism operably coupled to said circuit breaker, said reset mechanism configured to complete said tripped circuit permitting the power supply to said electrical appliance.

13. The integrated safety device according to claim 9, wherein said integrated safety device further comprises an alarm module operably coupled to the smoke detector, said alarm module is configured to receive said signal from said smoke detector and generate an audible alarm.

14. The electrical appliance according to claim 9, wherein said electrical appliance is an electrical kitchen appliance.

15. The electrical appliance according to claim 9, wherein said electrical appliance is an electrical household appliance.

16. The integrated safety device according to claim 9, wherein said electrical appliance is an electrical commercial appliance.

17. A method of preventing fire caused by faulty or overheating of an electrical appliance, said method comprises:
a. providing a smoke detector integrated in said electrical appliance, said smoke detector is configured for detecting levels of smoke produced by said faulty or overheated electrical appliance;
b. providing a means to shutoff said electrical appliance, said means to shutoff said electrical appliance is hardwired to said smoke detector and configured to receive a signal from said smoke detector and shutoff said electrical appliance.

18. The method according to claim 17, wherein said means to shutoff said electrical appliance is a circuit breaker, said circuit breaker is integrated in a power supply of said electrical appliance, said circuit breaker is adapted to be tripped on receiving the signal from said smoke detector cutting the power supply to said electrical appliance.

19. The method according to claim 17, wherein said method further comprise providing a reset mechanism, said reset mechanism is operably coupled to said means to shutoff said electrical appliance and configured to permit turning on said electrical appliance.

20. The method according to claim 17, wherein said method further comprise providing an alarm module, said alarm module operably coupled to the smoke detector, said alarm module is configured to receive said signal from said smoke detector and generate an audible alarm.
